(19) United States
(12) Patent Application Publication
(10) Pub. No.: US 2010/0177413 A1
(43) Pub. Date: Jul. 15, 2010

(54) VEHICLE MIRROR CONTROL WITH SEAT POSITION INFORMATION

(75) Inventors: Jin-Woo Lee, Rochester Hills, MI (US); Jihan Ryu, Rochester Hills, MI (US); Kwang-Keun Shin, Rochester Hills, MI (US); Bakhtiar Brian Litkouhi, Washington, MI (US)

Correspondence Address: CICHOSZ & CICHOSZ, PLLC, 129 E. COMMERCE, MILFORD, MI, 48381, US

(73) Assignee: GM GLOBAL TECHNOLOGY OPERATIONS, INC., DETROIT, MI (US)

(21) Appl. No.: 12/352,802

(22) Filed: Jan. 13, 2009

(51) Int. Cl. G02B 5/08

(52) U.S. Cl. 359/843

(57) ABSTRACT

Systems and methods for automatically adjusting the orientation of one or more mirrors present on a motorized vehicle are responsive to the spatial position of at least one component of a driver seat present in such motorized vehicle.

### TECHNICAL FIELD

This disclosure related to accessories for motorized vehicles including automobiles, trucks, earthmoving equipment, buses, seaworthy vessels, aircraft, and any conveyance which includes a plurality of mirrors to aid an operator or navigator in viewing their surroundings.

### BACKGROUND

Statements present in this background section shall not necessarily be construed as constituting prior art.

Since the advent of the automobile and other motorized vehicles, it has been generally desirable for operators of such vehicles to have the ready capability of knowing of the presence of objects in the vicinity of such vehicles during their operation. One aid useful towards such an end is the presence of one or more mirrors mounted either on the vehicle exterior, or within the operators compartment, i.e., interior of the vehicle. In the case of automobiles and semi-trucks, it is common for there to be a left side mirror mounted on the external of the vehicle on the driver side and a right side mirror mounted on the external of the vehicle on the passenger side to enable the operator to see what objects may be present on the left and right sides of the vehicles that are not in the forward visual view of the operator. Such mirrors are especially useful when engaging the vehicle in a reverse gear to avoid collisions with stationary objects or to aid in the operator guiding the vehicle and optionally a trailer that is attached to the vehicle to a desired destination. In addition, such mirrors provide information regarding the presence of other vehicles during highway travel, when a lane change maneuver may be desired.

A “rear-view” mirror is also commonly present in motorized vehicles, including trucks, automobiles, earth-moving equipment, etc. Typically positioned upon the dashboard of the vehicle, mounted to the front windshield, or on or near the headliner of the vehicle interior, the rear-view mirror provides an operator of the vehicle with a quick way to scan for the presence of objects behind the vehicle.

Important aspects of the use of mirrors as described above, are the horizontal and vertical orientation adjustments of each mirror present, since the angle at which the mirrors are oriented with respect to the vehicle operator are determinative of the field of view that is visible by the operator. Typically, the horizontal and vertical orientation adjustments of the rear-view mirror disposed on the interior of the vehicle are readily adjusted by the hand of the vehicle operator, as such mirrors are generally pivotally-mounted. In the early years of motorized vehicles, the horizontal and vertical orientation adjustments of externally-mounted mirrors required manual effort by the vehicle operator or other person. However, in recent years vehicle manufacturers have provided convenient adjustment of such mirrors through the use of servo motors present in these mirrors' housings, the actuation of which motors being controllable by suitable switches disposed within easy reach of the vehicle operator. Given differences in bodily measurements, such developments are welcomed by operators of vehicles which are operated by more than one person, as it is a simple matter for a current driver to quickly adjust the mirrors' horizontal and vertical orientation adjustments for cases when a previous driver had set the mirrors' orientation to their own liking, different from those desired by the current driver.

Another convenient feature often found in motorized vehicles is a provision for adjusting the orientation of the seat that the vehicle operator sits in or is otherwise disposed during operation of the vehicle (“driver seat”). Such a feature typically includes a plurality of servo motors, operator-actuatable switches for their control, and associated hardware useful for adjusting parameters which include the forward-backward position of the seat, the height of the seat from the vehicle floor, and the amount of tilt present in either or both of the bottom portion of the driver seat upon which a person sits, and the back portion of the driver seat.

### SUMMARY

A system useful for adjustment of the orientation of at least one mirror present on a motorized vehicle having a cabin and including a driver seat having at least one component includes a sensor for determining positional information that relates to the position of at least one component of the seat. The system also includes at least one sensor for determining a parameter selected from the group consisting of the horizontal attitude of the at least one mirror and the vertical attitude of the at least one mirror. At least one motor is operatively connected to the at least one mirror sufficiently to enable alteration of the parameter. A controller is configured to receive inputs including the positional information and the parameter. The controller has an output for selectively commanding actuation of the at least one motor, responsive to the positional information.

### BRIEF DESCRIPTION OF THE DRAWINGS

One or more embodiments will now be described, by way of non-limiting example, with reference to the accompanying drawings, in which:

FIGS. 1A, 1B, and 1C are overhead views of possible fields of view of vehicle side-mounted mirrors;

FIG. 2 is a schematic representation of a system in accordance with one embodiment of the present disclosure;

FIG. 3 is a pictorial representation of components of a system according to one embodiment of the disclosure;

FIG. 4 is a side view of a driver in the driver seat of a motorized vehicle according to one embodiment of the disclosure, showing parameters relevant to a desirable calculation;

FIG. 5 shows a side view of a driver in the driver seat of a motorized vehicle according to one embodiment of the disclosure, showing parameters relevant to a desirable calculation;

FIG. 6 shows an overhead view of a driver in the driver seat of a motorized vehicle according to one embodiment of the disclosure; and

In FIG. 7 is shown a side view of a driver in the driver seat of a motorized vehicle according to one embodiment of the disclosure, in which several relevant dimensions are shown.

### DETAILED DESCRIPTION

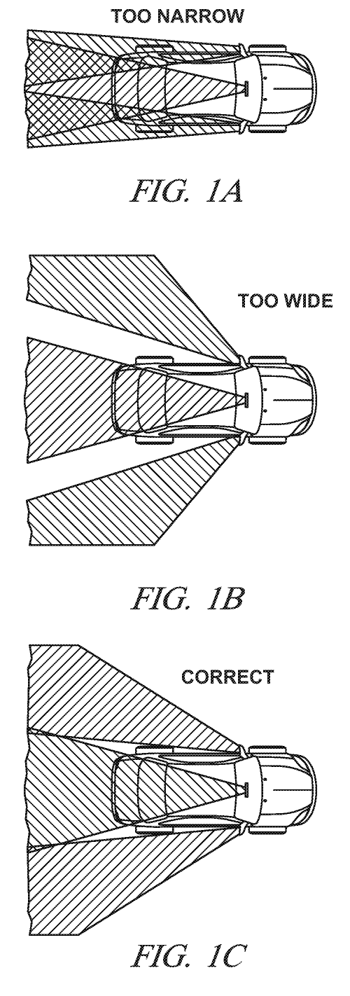

Referring now to the drawings, wherein the showings are for the purpose of illustrating certain exemplary embodiments only and not for the purpose of limiting the same, FIGS. 1A, 1B, and 1C are overhead views of possible fields of view of vehicle mounted mirrors. In FIG. 1A, the externally-mounted driver side and passenger side mirrors are adjusted to provide a field of view that may be regarded as being too narrow. In FIG. 1B, the externally-mounted driver side and passenger side mirrors are adjusted to provide a field of view that may be regarded as being too wide. FIG. 1C shows a correct adjustment of the driver side and passenger side mirrors to provide a desirable field of view. Generally speaking, the fields of view shown in FIG. 1C are more pertinent to vehicle operation than are the fields of view provided in FIGS. 1A and 1B, since the driver of a vehicle having its mirrors so adjusted as in FIG. 1C has ready-access, by mere eye movements, to more information concerning objects present in the surroundings of the vehicle that might be used in a decision to alter a control parameter of the vehicle, including braking, steering and acceleration/deceleration. In general, the information provided when mirrors are adjusted according to FIGS. 1A and 1B, provide less information that is pertinent to vehicle operation, thus such configurations are less pertinent to vehicle operation than desirable.

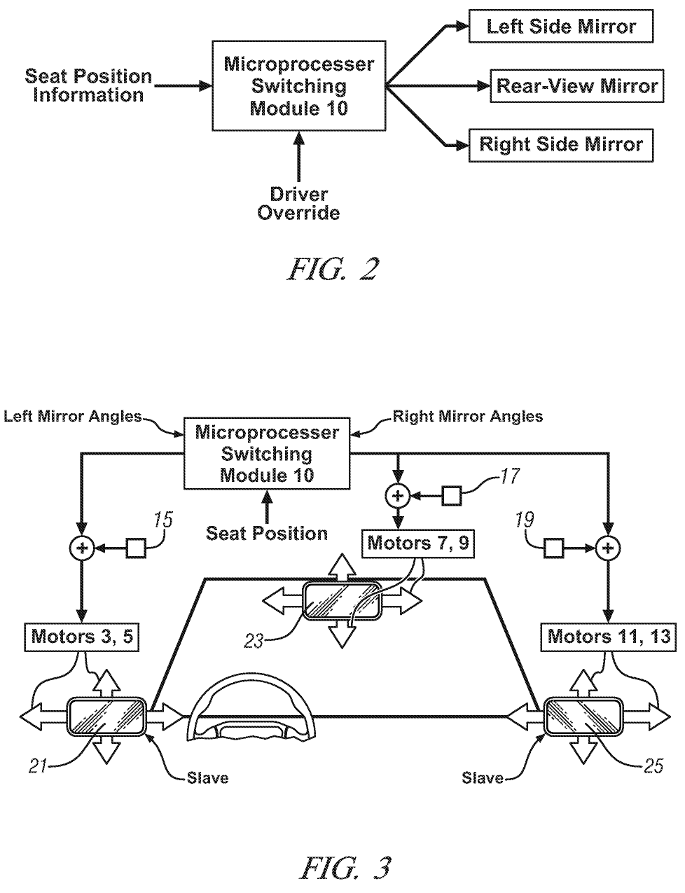

According to one embodiment of the present disclosure, the horizontal and vertical orientation adjustments of at least one of the left and right side mirrors, and the rear-view mirror on the vehicle, are controlled by a microprocessor-based system in response to the physical orientation of the seat in which the vehicle operator is disposed during vehicle operation. Such a system is shown schematically in FIG. 2, in which data relating to the position of the driver seat are provided as an input to microprocessor-controlled switching module, which is itself electrically operatively connected to one or more servo motors effectively configured to be in position-controlling mechanical contact with each of the pivotally-mounted left side mirror, right side mirror and the rear-view mirror. Although right side and left side mirrors are oriented with driver and passenger sides, respectively, systems and methods as herein provided are equivalently applicable to vehicles having the driver seat disposed on the right side of the vehicle, such as is common in the UK, or vehicles having centrally mounted driver seats, such as military wares. In one embodiment a system as provided herein comprises an override provision, which may comprise a manual switch, actuable by the vehicle operator to override automatic adjustment of any one or more of the mirrors present in such a system, for manual mirror adjustment.

FIG. 3 depicts such a system pictorially, showing the respective locations of left side mirror 21 having associated with it control motors 3 and 5, right side mirror 25 having associated with it control motors 11 and 13, and rear-view mirror 23 having associated with it control motors 7 and 9. Control motors 3, 5 are in selectively-switchable electrical communication with a microprocessor based switching module 10 (hereafter controller 10) through override switch 15, which in a preferred embodiment is disposed within reach of the vehicle operator within the interior of the motorized vehicle embodying such a system. Control motors 7, 9 are also in selectively-switchable electrical communication with controller 10 through override switch 17, which in a preferred embodiment is disposed within reach of the vehicle operator within the interior of the motorized vehicle. Control motors 11, 13 are also in selectively-switchable electrical communication with the controller 10 through override switch 17, which in a preferred embodiment is disposed within reach of the vehicle operator within the interior of the motorized vehicle.

In one embodiment, data including information relative to the position of the driver seat and the current or present angles of each of the mirrors with respect to a chosen reference point are used as inputs to controller 10, which uses these data in calculating desired vertical and horizontal angles for each of the mirrors and subsequently actuates the motors 3, 5, 7, 9, 11, 13 as deemed appropriate to alter the horizontal and vertical angles of mirrors 21, 23, 25 suitably to achieve desired adjustments for each of the mirrors, as calculated by the microprocessor using one or more methods as herein described.

Dimensions, parameters, and variables including distance dimensions and angles herein described that relate to the positions of various vehicle components, either with respect to the vehicle itself or to other vehicle components may be individually or collectively referred to as positional information.

In order to determine desirable horizontal and vertical angles of mirrors 21, 23, 25 according to the present disclosure, it is desirable to provide a location for the eyes of the vehicle operator, when the operator is present in the driver seat in the occupied position during vehicle operation. Once the location of the driver's eyes is reasonably known, adjustment for the mirrors' angles can be determined from the position of the driver seat.

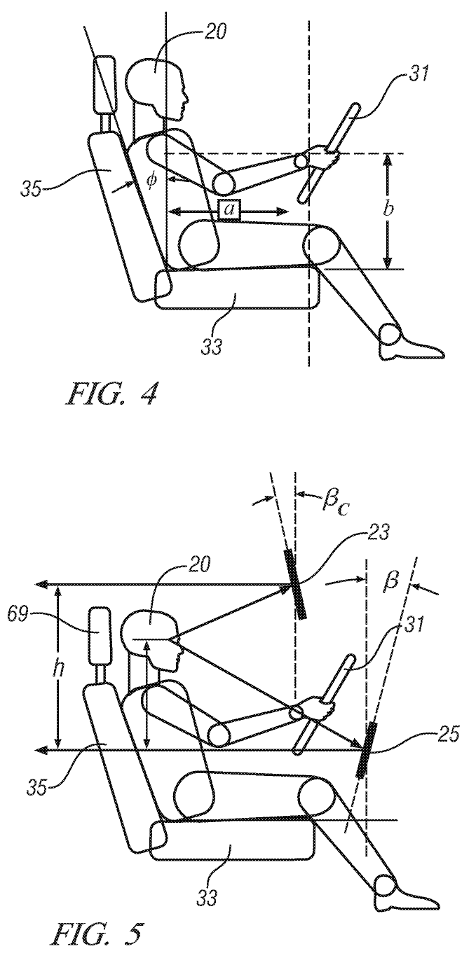

FIG. 4 shows a side view of a driver 20 in the driver seat of a motorized vehicle according to one embodiment of the disclosure, showing parameters relevant to a desirable calculation which include the parameter “a”, which is the distance between two substantially-parallel lines, the first being a first vertical line drawn through the centerpoint of the vehicle steering wheel 31 and the second being a second vertical line that intersects the point at which the bottom portion 33 of the driver seat intersects with its back portion 35, as viewed from a side perspective, as shown. Another parameter “b” is shown in FIG. 4, which is the distance between two substantially-parallel lines, the first being a first horizontal line drawn through the centerpoint of the vehicle side mirror 25 and the second being a second horizontal line that coincides with the top surface of the bottom portion 33 of the driver seat, as viewed from a side perspective, as shown. A third parameter “φ” is the angle between the second vertical line that intersects the point at which the bottom portion 33 of the driver seat intersects with its back portion 35, and the surface of the back portion 35 of the driver seat. In one embodiment, the parameters a, b, and φ are all obtained from knowing the geometry of the adjustable driver seat relative to the side mirror 25; the position of the seat components being monitored by position sensors within the seat. In an alternate embodiment, the seat position adjustment switches are routed through a microprocessor which continuously monitors the position of the seat components 33, 35 and the seat height.

FIG. 5 shows a side view of a driver 20 in the driver seat of a motorized vehicle according to one embodiment of the disclosure, showing vertical angles for mirrors 23 and 25 previously shown in FIG. 3. The angle β is the vertical angle that the surface of the mirror 25 disposed on the exterior of the vehicle makes with respect to a line drawn to be substantially normal to the surface upon which the vehicle rests, and the angle βc is the vertical angle that the rear-view mirror 23 makes with respect to a line drawn to be substantially normal to the surface upon which the vehicle rests. In one embodiment, these vertical angles β and βc are made with reference to a vertical line that is precisely normal to the surface on which the vehicle as a whole resides.

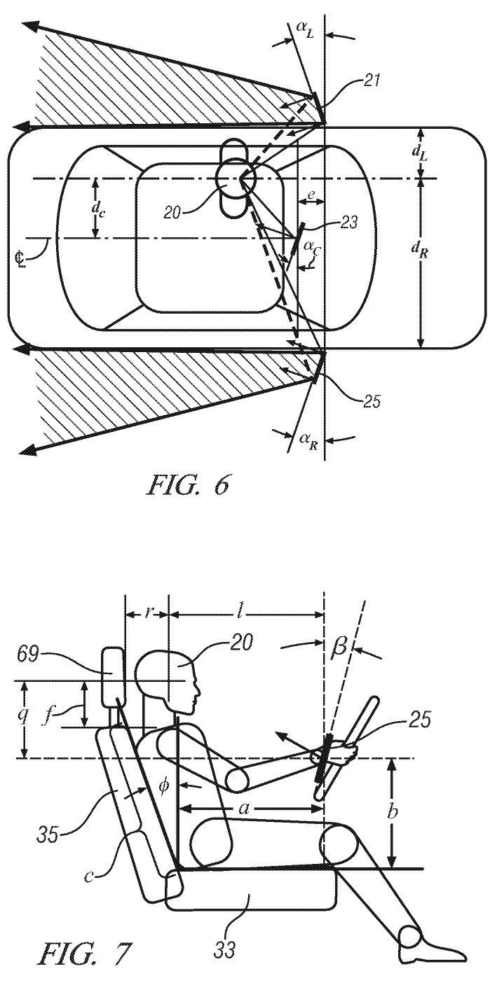

FIG. 6 shows an overhead view of a driver 20 in the driver seat of a motorized vehicle according to one embodiment of the disclosure, showing horizontal angles for mirrors 21, 23, and 25 previously shown in FIG. 3. The angles α_{L} and α_{R} are the horizontal angles that the surfaces of the left side mirror 21 and right side mirror 25 disposed on the exterior of the vehicle make with respect to a line drawn perpendicular to the vehicle centerline as shown, and the angle α_{C} is the horizontal angle that the surface of the rear-view mirror 23 disposed within the interior of the vehicle makes with respect to a line drawn perpendicular to the vehicle centerline, as shown. Also shown is the dimension d_{L} which is the distance between a line drawn through the center of the driver's head and the inboard edge of the left side mirror 21 as viewed from above as shown, and the dimension d_{R} which is the distance between a line drawn through the center of the driver's head and the inboard edge of the right side mirror 25, as viewed from this overhead perspective. Dimension d_{C} is the distance between two substantially-parallel lines, the first being a line drawn through the center of the driver's head and the second being a line drawn through the center of the rear-view mirror 23, as seen from an overhead perspective, as shown. The dimension “e” is the distance between two substantially-parallel lines, the first being a line which contacts the inboard edge of the left side mirror 23 and the inboard edge of the right side mirror 25, and the second being a line which passes through the center of the rear-view mirror 23, as seen from an overhead perspective. The mirror angles α_{L}, α_{R}, α_{C}, β and βc are calculated using data relating to the position of the seat components 33, 35, and the seat height, as will be shown.

FIG. 7 shows a side view of a driver 20 in the driver seat of a motorized vehicle according to one embodiment of the disclosure, in which several relevant dimensions are defined. The dimension “r” is the distance between the back of the driver's head and the center of the driver's head as viewed from a side perspective, as shown. The dimension “l” is the distance between the center of the surface of the mirror 25 and the center of the driver's head. The dimension “q” is the distance between a first horizontal line drawn through the centerpoint of the side mirror 25 and a second horizontal line that coincides with the vertical height of the driver's eyes, as seen from a side perspective. The dimension “f” is the distance between a horizontal line that coincides with the center of the seat headrest 69, as seen from a side perspective, and the top of the back portion 35 of the driver seat, as viewed from a side perspective. The dimension “c” is the distance between a horizontal line that coincides with the top surface of the bottom portion 33 of the driver seat and a horizontal line drawn through the top of the back portion 35, as viewed from a side perspective. The dimensions a, b, φ, and β are as previously described.

The foregoing dimensions having been defined, it is now possible to determine values for the unknown parameters (dimensions) based on those which are known, for the case where the driver seat positional information is used to determine adjustment angles for the side mirrors 21 and 25. Generally speaking, the dimensions a, b and 4 are provided by monitoring positional data associated with the driver seat. Further, the dimensions c, f, r, d_{R} and d_{L} are measurable, known parameters. The remaining dimensions α_{L}, α_{R}, l and q are now calculated. From geometrical considerations the dimension l is provided by:

l=a−r+c sin φ [1]

and the dimension q is provided by:

q=f−b+c cos φ. [2]

Once l and q are found, calculation of β is enabled by:

$$β = \frac{1}{2} {tan}^{- 1} ( \frac{q}{l} ) \qquad [ 3 ]$$

where α_{R} and α_{L} are thenceforth provided by:

$$\begin{matrix}{α}_{R} = \frac{1}{2} {tan}^{- 1} ( \frac{{d}_{L}}{l} ) \\ and & [ 4 ] \\ {α}_{L} = \frac{1}{2} {tan}^{- 1} ( \frac{{d}_{R}}{l} ) & [ 5 ]\end{matrix}$$

respectively.

It is additionally now possible to determine values for the unknown parameters based on those which are known, for the case where the driver seat positional information is used to determine adjustment angles for the rear-view mirror 23. The dimensions a, b, and φ are provided by monitoring positional data associated with the driver seat. Further, the dimensions d_{C}, h, f, r, and e are measurable, known parameters. The remaining dimensions α_{L}, α_{R}, l are now calculable, l being provided as above, with α_{C}, and βc given by:

$$\begin{matrix}{α}_{C} = \frac{1}{2} {tan}^{- 1} ( \frac{{d}_{C}}{l - e} ) \\ and & [ 6 ] \\ {β}_{C} = \frac{1}{2} {tan}^{- 1} ( \frac{h - f + b - C cos φ}{l - e} ) & [ 7 ]\end{matrix}$$

respectively.

Thus, given positional information relative to portions of the driver seat and known dimensions of features present within the interior cabin of a motorized vehicle, calculation of angles suitable for use in a process or system for the automatic adjustment of left and right side mirrors and the rear-view mirror is provided. As is evident from the foregoing, the identification of appropriate parameters and the calculations provided essentially and inherently determine the substantial position of the eyes of a driver stationed in the driver seat of the vehicle.

In one embodiment, subsequent automatic adjustment of the angular position of the mirrors so that the field of view visible to the driver through each of the mirrors is a desirable field of view is advantageously carried out through servo motors which are microprocessor-controlled. Known servo motors and mirror assemblies containing same are suitable for use in a system according to the present disclosure, such a system in one embodiment requiring a first servo motor for adjusting the vertical angle of the mirror and a second servo motor for adjusting the horizontal of the mirror. In one embodiment, vehicle engineers input data relating to fixed parameters concerning features present to the interior cabin of a particular vehicle that is to be equipped with a system of this disclosure. Positional sensors are provided at selected locations on the components of the driver seat, which may be conventional position sensing sensors or means. Data from such sensors are used as an input to a microprocessor, which, along with data relating to fixed parameters provided by vehicle engineers, are used in calculating the various angles described herein using the equations above. Once the angles have been calculated, the microprocessor then commands the servo motors to the positions determined by the angle calculations. In one embodiment, each of the mirrors 21, 23, 25 are themselves provided with position sensors within their proximity for providing information concerning their horizontal and vertical degree of tilt to the microprocessor, to aid the microprocessor in achieving the desired horizontal and vertical orientations of the mirrors.

For use of a system according to this disclosure, a driver enters a vehicle so-equipped, sits in the driver seat, and adjusts the seat to their liking. The angles of the mirrors 21, 23, and 25 automatically adjust to provide the driver with a desirable field of view for each of the mirrors. Although described in some embodiments as being useful in vehicles having seats whose positions are electronically controllable, the present disclosure is also applicable to vehicles having seats whose positions are not adjustable electronically using servo motors and for such embodiments position sensors for sensing the pertinent positional parameters of the driver seat components are present.

Sensors for determining a relative position, orientation, or a component thereof for any vehicle component, including without limitation mirrors and seats, useful in accordance with this disclosure are known in the art. In some instances an actual physical sensor, including magnetic, light-based, ultrasound-based or other known sensors may be employed. In other instances, the sensor can effectively comprise gears or other components of a mechanical contrivance, the number of teeth rotated being counted and stored in memory as an effective sensor, or the amount of rotation of a drive shaft of a mirror-controlling or seat-controlling motor being monitored and stored in memory as being another effective sensor. Current and recent production vehicles having systems that provide driver-storable seat and mirror position within an on-board memory effectively include one or more sensors and microprocessor-based controls for the positions of vehicle mirrors and seats, which may be used in accordance with this disclosure. Such exemplary systems and methods are known in the art and shall not be construed as being delimitive of this disclosure.

The disclosure has described certain preferred embodiments and modifications thereto. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. A system useful for adjustment of the orientation of at least one mirror present on a motorized vehicle having a cabin and comprising a driver seat having at least one component, said system comprising:
a sensor for determining positional information that relates to the position of at least one component of said seat;
at least one sensor for determining a parameter selected from the group consisting of: the horizontal attitude of said at least one mirror, and the vertical attitude of said at least one mirror;
at least one motor operatively connected to said at least one mirror sufficiently to enable alteration of said parameter;
a controller configured to receive inputs comprising said positional information and said parameter, said controller having an output for selectively commanding actuation of said at least one motor, responsive to said positional information.

2. A system according to claim 1 wherein said at least one mirror comprises a rear-view mirror affixed to said vehicle at a location inside of the vehicle cabin.

3. A system according to claim 1 wherein said at least one mirror comprises at least one of a left side mirror and a right side mirror which are affixed to said vehicle at locations outside of the vehicle cabin.

4. A system according to claim 1 wherein said at least one mirror comprises a rear-view mirror, a left side mirror, and a right side mirror.

5. A system according to claim 1 wherein the position of at least one component of said driver seat is electrically adjustable via motors actuable by an operator of said vehicle.

6. A system according to claim 1 wherein any orientation deemed desirable for the horizontal attitude of said at least one mirror is provided by at least one calculation performed by said controller.

7. A system according to claim 1 wherein any orientation deemed desirable for the vertical attitude of said at least one mirror is provided by at least one calculation performed by said controller.

8. A system according to claim 1 wherein commanding actuation of said at least one motor effectively adjusts position of said at least one mirror so that the field of view presented by said at least one mirror to an operator of said vehicle present in said driver seat is more pertinent to vehicle operation than would be the field of view presented by said at least one mirror prior to said position adjustment.

9. A system according to claim 1, further comprising at least one override switch which when engaged effectively disables said system to permit manual adjustment of said at least one mirror.

10. A system according to claim 1 wherein said output for selectively commanding actuation of said at least one motor, responsive to said positional information is additionally responsive to said parameter.

11. Method for adjustment of the orientation of at least one mirror present on a motorized vehicle comprising a driver seat having at least one component, comprising:
determining positional information relating to the position of at least one component of said seat;
determining a parameter selected from the group consisting of the current horizontal attitude of said at least one mirror, and the current vertical attitude of said at least one mirror;
determining a desirable spatial orientation for said at least one mirror in terms of its horizontal angle and vertical angle components; and
altering said parameter effective to substantially achieve said desirable spatial orientation, responsive to said positional information.

12. Method according to claim 11 further comprising:
altering the position of said at least one component of said seat so as to cause a change in said positional information;
determining altered positional information relating to the altered position of at least one component of said seat; and
subsequently altering said parameter, responsive to said altered positional information.

13. Method according to claim 11 wherein altering said parameter involves altering both the horizontal and vertical attitude of said at least one mirror.

14. Method according to claim 11 wherein altering said parameter is effected using at least one motor operatively connected to said at least one mirror.

15. Method for adjustment of the orientation of at least one mirror present on a motorized vehicle comprising a driver seat having at least one component, comprising:
determining the location of the eyes of an operator of said vehicle positioned in said driver seat; and
altering at least one parameter selected from the group consisting of the horizontal attitude of said at least one mirror and the vertical attitude of said at least one mirror, responsive to said determined location of the eyes.

16. Method according to claim 15 wherein altering at least one parameter includes changing both the horizontal attitude of said at least one mirror, and the vertical attitude of said at least one mirror.

17. Method according to claim 15 wherein altering at least one parameter effectively adjusts position of said at least one mirror so that the field of view presented by said at least one mirror to an operator of said vehicle present in said driver seat is more pertinent to vehicle operation than would be the field of view presented by said at least one mirror prior to said position adjustment.
